(19) United States
(12) Patent Application Publication
(10) Pub. No.: US 2022/0242423 A1
(43) Pub. Date: Aug. 4, 2022

(54) DETERMINING A SIGNAL STATE OF A TRAFFIC LIGHT DEVICE

(71) Applicant: Valeo Schalter und Sensoren GmbH, Bietigheim-Bissingen (DE)

(72) Inventor: Thomas Heitzmann, San Mateo, CA (US)

(73) Assignee: Valeo Schalter und Sensoren GmbH, Bietigheim-Bissingen (DE)

(21) Appl. No.: 17/626,309

(22) PCT Filed: Jul. 8, 2020
(86) PCT No.: PCT/EP2020/069184

§ 371 Date: Jan. 11, 2022

(30) Foreign Application Priority Data
Jul. 15, 2019 (DE) 10 2019 119 084.3

(51) Int. Cl. B60W 50/00; G08G 1/0962; B60W 60/00

(52) U.S. Cl. CPC B60W 50/0097; G08G 1/09626; B60W 2554/404; B60W 2555/60; B60W 60/001

(57) ABSTRACT

According to a method for determining a signal state of a traffic light device (12), a state of movement of at least one further vehicle (13, 14, 15, 16, 17, 18) is determined by means of a sensor system (9) of an ego vehicle (7). The probability for the signal state is determined by means of a computing unit (10) of the ego vehicle (7) depending on the determined state of movement.

The present invention relates to a method for determining a signal state of a traffic light device, a method for automatic control of an ego vehicle, an electronic vehicle guidance system comprising a sensor system of an ego vehicle and a computing unit coupled to the sensor system, as well as to a computer program.

At a road intersection controlled by a traffic light device, the situation can occur that the traffic light device is obstructed for a sensor system or a driver of an ego vehicle, in particular by another vehicle, for example a truck.

Document DE 10 2017 203 236 A1 describes a system for detecting an actual traffic light phase by means of an image sensor device. Therein, contrast values of an image taken by the image sensor device, camera parameters and saturation or luminosity information of the image are taken into account to determine the actual signal phase.

However, according to existing approaches, the signal phase cannot be determined in case the relevant traffic light device is obstructed for the camera system.

Therefore, it is an object of the present invention to provide an improved concept for determining a signal state of a traffic light device that allows for an automatic determination of the signal state even in case the traffic light device is obstructed.

According to the improved concept, this object is achieved by means of the respective subject-matter of the independent claims. Further implementations and beneficial embodiments are subject-matter of the dependent claims.

The improved concept is based on the idea to determine by means of an ego vehicle the absence or presence of a movement of another vehicle to compute a probability for a signal state of a traffic light device.

According to a first independent aspect of the improved concept, a method for determining a signal state of a traffic light device is provided. Therein, by means of a sensor system of an ego vehicle, a state of movement of at least one further vehicle is determined. A probability for the signal state is determined by means of a computing unit of the ego vehicle depending on the determined state of movement.

The ego vehicle can be understood as a vehicle for which the signal state of the traffic light device is relevant. In particular, the traffic light device is a traffic light device relevant for the ego vehicle. In other words, it depends on the actual signal state of the traffic light device whether the ego vehicle is allowed to drive or is required to stop.

For example, the method may be employed in a traffic situation such as the ego vehicle standing at or approaching a road intersection on a lane controlled by the traffic light device.

The signal state of the traffic light device can be understood as one of at least two predefined signal states of the traffic light device. The signal state may for example correspond to a red light state or a green light state of the traffic light device. The signal state may also correspond to an off-state of the traffic light device. In particular, the method according to the improved concept may be performed for different possible signal states of the same traffic light device. For example, the probability may be determined by means of the method for the green light state and for the red light state independent of each other.

Here and in the following, a red light state of the traffic light device can be understood as a signal state of the traffic light device that requires the ego vehicle to stop or not to drive. Furthermore, a green light state of the traffic light device may be understood as a signal state allowing the ego vehicle to drive or to pass the intersection.

Determining the state of movement of the at least one further vehicle may for example include determining respective states of movement for a plurality of sampling frames of the sensor system.

The state of movement of the at least one further vehicle may be understood as containing individual states of movement of each of the at least one further vehicles. In particular, the state of movement of the at least one further vehicle can be understood as an overall state of movement of all vehicles of the at least one further vehicle.

The sensor system may for example be implemented as a camera system including one or more cameras.

The described method steps may for example be performed in case the signal state of the traffic light device is obstructed such that it cannot be directly determined by the sensor system and/or cannot be seen by a driver of the vehicle due to an object arranged between the traffic light device and the sensor system and/or between the traffic light device and the driver.

For example, it may be determined by means of the sensor system whether the signal of the traffic light device is obstructed. The method steps described above may be performed in particular if it is found that the traffic light device is obstructed.

The vehicle may in particular be designed as a vehicle for partly or fully automatic or autonomous driving or self-driving, in particular according to one of levels 1 to 5 of the SAE J3016 classification. Here and in the following, SAE J3016 refers to the respective standard dated June 2018.

The state of movement of the at least one further vehicle being determined by means of the sensor system can be understood such that the sensor system is used for determining the state of movement. In particular, it is not excluded that other components or devices, in particular the computing unit or a further computing unit, is used for determining the state of movement, too, for example based on sensor signals or image data generated by the sensor system.

The individual state of movement of one the further vehicles may for example be understood such that the respective further vehicle is moving or is standing still or for example accelerates or decelerates. The individual state of movement may also comprise information regarding the respective further vehicle turning at the intersection.

By determining the probability for the signals as described for a method according to the improved concept, an indication for the actual signal state of the traffic light device may be automatically determined from traffic flow information even if the view of a driver of the vehicle and/or a field of view of the sensor system is obstructed such that the actual signal state of the traffic light device cannot directly be seen by the driver and/or the sensor system.

The information given by the probability of the signal state may for example be used for fully or partly autonomous driving functions or as information for a driver in case of a manually controlled vehicle.

According to several implementations of the method, at least one further signal state of at least one further traffic light device is determined by means of the sensor system and/or by means of a further sensor system. Interrelation data are received by the computing unit from a database, the interrelation data comprising an interrelation, in particular information regarding an interrelation or rules regarding the interrelation, between the signal state of the traffic light device and the at least one further signal state. The probability for the signal state is determined, in particular by means of the computing unit, depending on the interrelation data.

In particular, the at least one further traffic light device is not directly relevant for the ego vehicle. This means, the at least one further traffic light device is not intended to signal to the driver of the ego vehicle or to the ego vehicle directly whether it is allowed to pass or it shall stop.

The at least one further traffic light device may for example correspond to one or more further traffic light devices at the same intersection as the traffic light device relevant for the ego vehicle, however, may be directed to another road at the intersection than the ego vehicle is driving or standing on.

The further sensor system may for example be a sensor system external to the ego vehicle that is not comprised by the ego vehicle. For example, the further sensor system may correspond to a sensor system of another vehicle, in particular one of the further vehicles, or of an infrastructure device in a vicinity of the ego vehicle. The at least one further signal state may for example be received by the computing unit of the ego vehicle for example via a vehicle-to-vehicle or car-to-car, C2C communication interface and/or via a vehicle-to-vehicle environment or car-to-car environment, C2X communication interface.

The database may for example be comprised by a storage medium of the ego vehicle. Alternatively or in addition, the database may be comprised by an external device, a computer or server, for example by a cloud computer.

The interrelation data may be for example received by the computing unit of the ego vehicle via the C2C or C2X communication interface or via a further communication interface.

By taking into account the interrelation data and the further signal states of the further traffic light devices, a higher confidence value for the signal state of the traffic light device to be determined may be achieved. In particular, by taking into account different sources of information, namely the interrelation data together with the further signal state and the state of movement of the further vehicles, a more robust determination of the signal state of the traffic light device may be achieved.

The interrelation data may for example comprise rules such that the signal state of the traffic light device is indirectly given with a certain probability by the at least one further signal state.

For example, on an intersection with four meeting lanes, opposite traffic light devices may be configured to be usually or mostly the same signal state. Analogously, remaining traffic light devices at an intersection may for example be configured such that they are usually or mostly in an opposite signal state than the traffic light device under consideration.

According to several implementations, the interrelation data are received by the computing unit from a map database, in particular from a high definition map, HD-map.

The HD-map can for example be understood as a map database with a precision in a range of one or several centimeters.

The map database may for example be augmented with additional information, such as the interrelation data.

The map database may for example comprise information concerning the traffic light device such as the signal state of the traffic light device in case one or more further traffic light devices are in respective given signal states.

According to several implementations, a basic probability is determined by means of the computing unit depending on the interrelation data and the probability for the signal state is determined by means of the computing unit depending on the basic probability.

The basic probability may for example be a part of the probability for the signal state that is fixed or time independent. This may for example be the case since the interrelation data may not change over time.

According to several implementations, a correction value depending on the determined state of movement is computed by means of the computing unit. The probability for the signal state is determined as a sum of the basic probability and the correction value by means of the computing unit.

According to several implementations, the correction value is computed as a product of a predefined constant numeral factor and a time dependent factor, the time dependent factor depending on the determined state of movement.

According to several implementations, the state of movement of the at least one further vehicle is determined at a first time and at a second time by means of the sensor system. A deviation between the states of movement determined at the first and at the second time is analyzed or determined by means of the computing unit. The probability of the signal state is determined by means of the computing unit depending on the deviation.

Therein, the first and the second time may correspond to respective individual time frames or respective series of consecutive time frames.

In particular, the state of movement determines that the first time is stored by means of the computing unit. In particular, the second time lies after the first time.

For example, the probability for the signal state may differ in cases when there is a change of the state of movement of the at least one further vehicle, compared to a situation where there is no change of the state of movement. For example, if a given further vehicle is standing still at the first time and moving at the second time, this may be interpreted as an indication that a respective one of the further traffic light device has turned from red light to green light.

According to several implementations, an individual state of movement of each vehicle of the at least one further vehicle is determined by means of the sensor system. A consistency of the individual states of movement is analyzed by means of the computing unit. The probability for the signal state is determined by means of the computing unit depending on a result of the analysis of the consistency.

The individual states of movement of all vehicles of the at least one further vehicle make up for example the state of movement of the at least one further vehicle.

The consistency may for example be understood such that the consistency is higher the more individual states of movement indicate the same signal state of the traffic light device.

In particular, the lower the consistency value is, the lower may be the probability for the given signal state for the traffic light device.

If the consistency is maximum, for example if all individual states of movement imply the same signal state, the probability may for example depend on the number of individual states of movement taken into account. For example, the more individual states of movement are consistent, the higher the respective probability may be.

According to several implementations, a number of consistent vehicles is determined by means of the computing unit based on the individual states of movement and the probability for the signal state is determined by means of the computing unit depending on the number of consistent vehicles.

As described above, the number of consistent vehicles corresponds to a number of individual states of movement determining that all imply the same signal state for the traffic light device.

Therefore, a confidence level of the determined probability for the signal state may be further increased.

According to several implementations, the state of movement of the at least one further vehicle is determined repeatedly for consecutive frames of the sensor system, in particular by means of the sensor system. A further consistency of the states of movement determined for the frames is analyzed by means of the computing system and the probability for the signal state is determined by means of the computing unit depending on the result of the analysis of the further consistency.

A frame of the sensor system can for example be understood as a set of sensor data or a sensor signal generated during a predefined sampling period. In other words, the frames correspond to consecutive sampling periods of the sensor system.

The further consistency of the states of movement may be understood such that it depends on whether the state of movement is the same or implies the same signal state for the traffic light device during all frames of the consecutive frames.

If the further consistency is given, the probability for the signal state of the traffic light device is higher.

In this way, an even higher confidence level of the determined probability may be achieved. For example, the computing unit or an electronic vehicle guidance system of the ego vehicle may be configured not to cause any actions or reactions to the assumed signal state of the traffic light device as long as the determined probability is lower than a predefined minimum probability. The probability may for example increase over time with an increasing number of further vehicles for which the individual state of movement has been determined and/or over the number of consistent time frames.

In particular, the correction value, in particular, the time dependent factor, may be determined depending on the deviation and/or depending on the result of the analysis of the consistency and/or depending on the number of consistent vehicles and/or depending on the result of the analysis of the further consistency.

According to several implementations, an information signal is generated by means of the computing unit depending on the probability for the signal state.

The information signal may for example be output to the driver of the vehicle. In this way, manual driving of the ego vehicle may be supported in case the view of the driver is obstructed such that the driver cannot see the traffic light device.

According to a further independent aspect of the improved concept, a method for automatic control of an ego vehicle is provided. Therein, a probability for a signal state of a traffic light device is determined by means of a method for determining a signal state of the traffic light device according to the improved concept. The ego vehicle is controlled by means of an electronic vehicle guidance system of the ego vehicle depending on the probability for the signal state.

In particular, the ego vehicle may be designed for partly or fully autonomous driving according to level 1 to 5 of the SAE J3016 classification.

By means of a method for automatic control of an ego vehicle according to the improved concept, the automatic control of the ego vehicle may be enabled also in case of obstruction of the sensor system of the ego vehicle.

The computing unit and/or the sensor system may for example be part of the electronic vehicle guidance system.

According to several implementations of the method for automatic control of an ego vehicle, the probability for the signal state is compared to a predefined minimum confidence value by means of the computing unit. The ego vehicle is controlled depending on a result of the comparison by means of the electronic vehicle guidance system.

In particular, if it is found that the probability is greater than or equal to the minimum confidence value, the ego vehicle may be controlled to continue driving or pass the intersection. In case the probability is lower than the minimum confidence value, the ego vehicle may be controlled to stop or remain standing still.

In particular, the predefined minimum confidence value may depend on the type of the signal state of the traffic light device. For example, the minimum confidence level may be greater for a green light signal compared to a red light signal.

According to a further independent aspect of the improved concept, an electronic vehicle guidance system comprising a sensor system of an ego vehicle and a computing unit, in particular of the ego vehicle, coupled to the sensor system is provided. The sensor system is configured to or the sensor system together with the computing unit are configured to determine a state of movement of at least one further vehicle. The computing unit is configured to determine a probability for a signal state of a traffic light device depending on the determined state of movement.

The state of movement being determined by means of the sensor system can be understood such that the state of movement is determined using the sensor system but not necessarily using only the sensor system.

According to several implementations, the computing unit is configured to receive at least one further signal state of at least one further traffic light device, wherein the at least one further signal state is, in particular determined by means of the sensor system and/or by means of a further sensor system. The electronic vehicle guidance system comprises a database storing interrelation data, wherein the interrelation data comprise an interrelation between the signal state of the traffic light device and the at least one further signal state. The computing unit is configured to determine the probability for the signal state depending on the interrelation data.

The database may be a database of the ego vehicle or may be external to the ego vehicle.

Further implementations of the electronic vehicle guidance system according to the improved concept follow directly from the various implementations of the method for determining a signal state according to the improved concept and from the method for automatic control of an ego vehicle according to the improved concept and vice versa, respectively. In particular, an electronic vehicle guidance system according to the improved concept may be designed to or programmed to perform a method according to the improved concept or the electronic vehicle guidance system performs a method according to the improved concept.

According to a further independent aspect of the improved concept, a vehicle, in particular a partially or fully autonomously drivable vehicle, is provided, the vehicle comprising an electronic vehicle guidance system according to the improved concept.

According to a further independent aspect of the improved concept, a computer program comprising instructions is provided. If the computer program is executed by an electronic vehicle guidance system according to the improved concept, the instructions cause the electronic vehicle guidance system to perform a method for automatic control of an ego vehicle according to the improved concept and/or a method for determining a signal state of a traffic light device according to the improved concept.

According to a further independent aspect of the improved concept, a computer readable storage medium storing a computer program according to the improved concept is provided.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not have all of the features of an originally formulated independent claim. Moreover, implementations and feature combinations are to be considered as disclosed, in particular by the implementations set out above, which extend beyond or deviate from the feature combinations set out in the relations of the claims.

In the figures

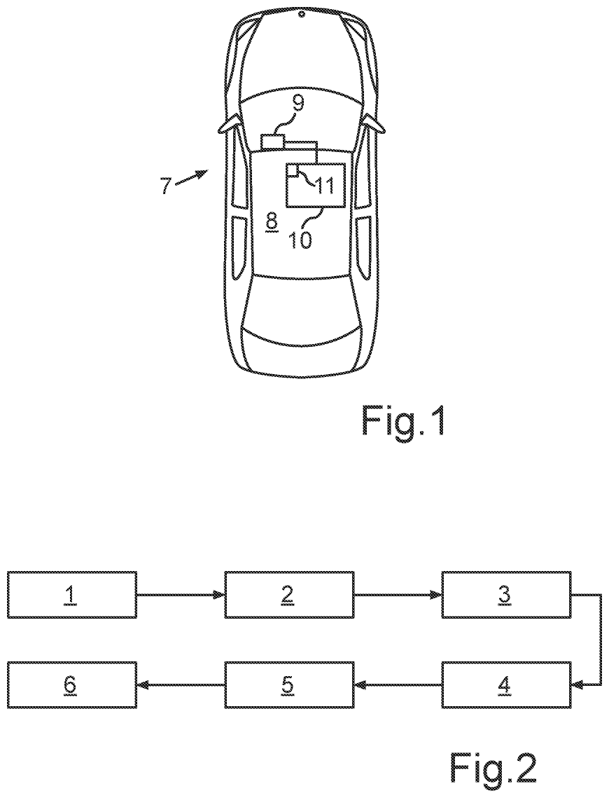

FIG. 1 shows a schematic representation of a vehicle comprising an exemplary implementation of an electronic vehicle guidance system according to the improved concept;

FIG. 2 shows a flow diagram of an exemplary implementation of a method according to the improved concept;

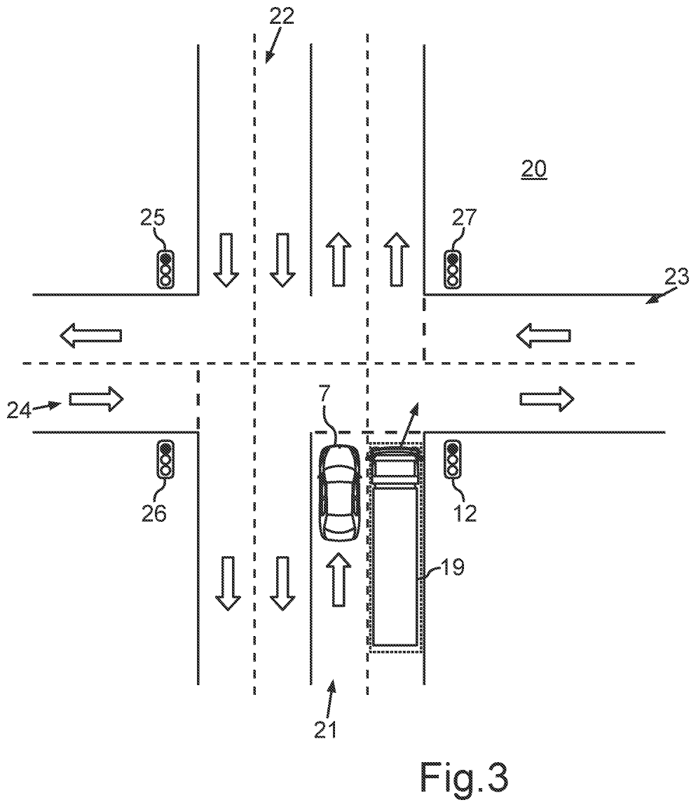

FIG. 3 shows a first traffic situation relating to a further exemplary implementation of a method according to the improved concept;

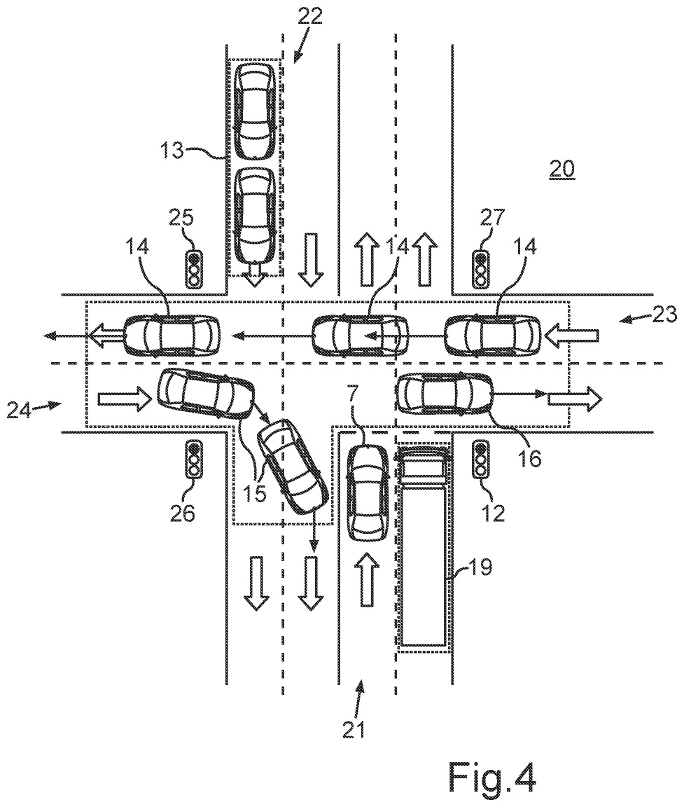

FIG. 4 shows a second traffic situation relating to a further exemplary implementation of a method according to the improved concept; and

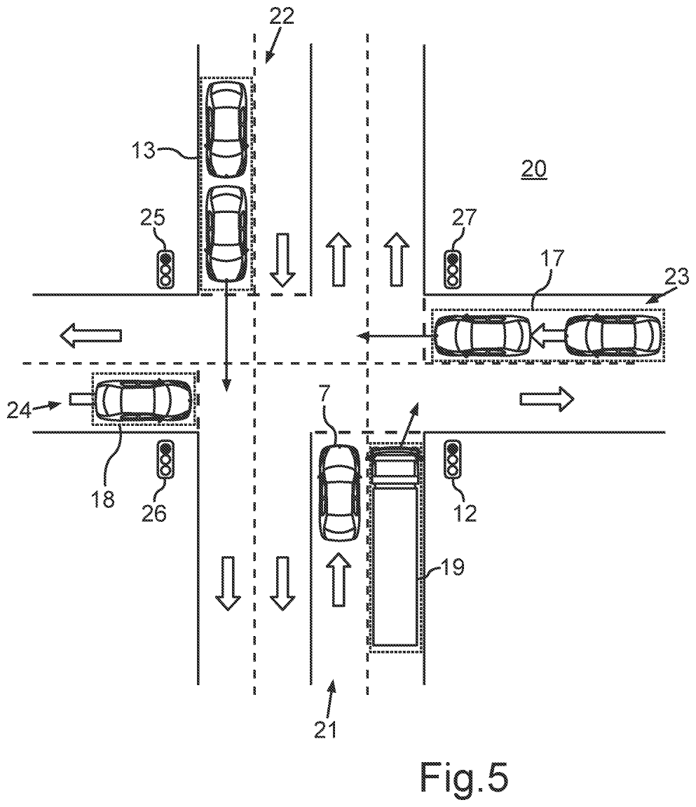

FIG. 5 shows a third traffic situation relating to a further exemplary implementation of a method according to the improved concept.

FIG. 1 shows a vehicle 7 comprising an exemplary implementation of an electronic vehicle guidance system 8 according to the improved concept.

The electronic vehicle guidance system comprises a camera system 9 configured to depict objects in an environment of the ego vehicle 7 and generate respective camera signals during consecutive sampling frames. The vehicle guidance system 8 comprises a computing unit 10, which may for example be implemented as an electronic control unit (ECU) of the ego vehicle 7. The computing unit 10 is coupled to the camera system 9 to receive the camera signals.

The computing unit 10 may comprise or be coupled to a computer readable storage medium 11. The computer readable storage medium 11 may for example store a database comprising an HD-map.

Optionally, the storage medium 11 may be implemented according to the improved concept and comprise a computer program according to the improved concept. The computing unit 10 may execute the computer program and the guidance system 8 may consequently be caused to execute or perform a method according to the improved concept.

The operation of the electronic vehicle guidance system 8 will be explained in more detail in the following with respect to exemplary implementations of methods according to the improved concept and, in particular with respect to FIG. 2 to FIG. 5.

FIG. 2 shows a flow diagram of an exemplary method according to the improved concept. The method will be described with reference to exemplary traffic situations depicted in FIG. 3 to FIG. 5.

In step 1 of the method, the ego vehicle 7 may for example arrive at an intersection 20 as shown in FIG. 3.

The intersection 20 may for example comprise an ego lane 21, the ego vehicle 7 is approaching the intersection 20 on the ego lane 21. The intersection 20 may comprise a further lane 22 along an opposite direction than the ego lane 21. Furthermore, the intersection 20 may comprise two further lanes 23, 24 oriented opposite to each other and perpendicular to the ego lane 21. For each of the lanes 21, 22, 23, 24, a corresponding traffic light device 12, 25, 26, 27 is arranged on the intersection. In particular, the traffic light device 12 is relevant for the ego vehicle 7, while the remaining traffic light devices 25, 26, 27 are not relevant or only indirectly relevant to the ego vehicle 7.

Furthermore, a truck 19 may be present at the ego lane 21 and may obstruct the traffic light device 12 such that the camera system 9 or the driver of the ego vehicle 7 cannot see the signal state of the traffic light 12.

In step 2 of the method, the ego vehicle 7 may stand still at the intersection 20 next to the obstructing truck 19. As shown in FIG. 4, several further vehicles 13, 14, 15, 16 may be present at the intersection 20. For example, vehicles 14 may be present and driving on the lane 23, while vehicles 15 may turn for example right coming from lane 24 into lane 22. A further vehicle 16 may drive on lane 24 and may for example have already passed the intersection 20. On lane 22, further vehicles 13 may stand still in front of the respective traffic lights 25. The obstructing truck 19 may also stand still.

In step 2 of the method, further camera systems comprised for example by individual vehicles of the further vehicles 13, 14, 15, 16 and/or by other infrastructure devices may determine the actual signal states of the further traffic lights 25, 26, 27. These signal states may for example be provided to the computing unit 10 of the ego vehicle 7 via a C2C or C2X communication interface of the ego vehicle 7.

The computing unit 10 may also retrieve an interrelation between the traffic lights 12 and the further traffic lights 25, 26, 27 from the database. The HD-map may for example comprise the interrelation data for traffic light 12, which may be retrieved by the computing unit 10. For example, in an exemplary situation as shown in FIG. 4, the interrelation may comprise the information that traffic lights 25 and 12 usually are in the same signal state. Additionally, the interrelation data may comprise that the traffic lights 26 and 27 usually are in an opposite signal state than traffic lights 12 and 25. For example, if traffic lights 12 are red, traffic lights 25 are red, too, while traffic lights 27 and 26 are green. Oppositely, if traffic lights 12 are green, also traffic lights 25 are green, while traffic lights 27 and 26 are red.

From the interrelation data, the computing unit 10 may for example calculate in step 3 of the method a basic value for a probability of the signal state of the traffic lights 12.

In the example of FIG. 4, the traffic lights 25 may for example be red, while the traffic lights 26 and 27 may be green. Therefore, the basic probability for the red signal state of the traffic lights 12 is relatively high.

To refine the assessment of the signal state of the traffic lights 12, the camera system 9 may in step 4 of the method determine a state of movement of the further vehicles 13, 14, 15. The state of movement may in particular comprise individual state of movement of all further vehicles 13, 14, 15, 16. As explained above, vehicles 13 may be standing still, while vehicles 14 and 16 may move straight-forwardly and vehicles 15 may turn right.

From this information, the computing unit 10 may compute a, for example time dependent, correction value to the probability, for example for the traffic lights 12 being in the red signal state. Since the state of movement of the further vehicles 13, 14, 15, 16 as well as the state of movement of the obstructing truck 19, namely standing still also, indicate that the traffic lights 12 are red. Therefore, the correction value is positive.

The correction value may for example be time-dependent in that the computing unit 10 may determine, how many further vehicles 13, 14, 15, 16 are observed and their state of movement is consistent with the traffic lights 12 being in the red signal state. Since the number of further vehicles may change, also the correction value may be time-dependent.

Furthermore, the correction value may for example increase over time, when during an increasing number of consecutive frames of the camera system 9, the same state of movement of the individual vehicles 13, 14, 15, 16, is determined.

Consequently, the probability for red light may increase over time.

Considering FIG. 5, the situation is changed with respect to the situation of FIG. 4. In particular, the basic probability may have changed since the computing unit 10 may have obtained different signal states for the further traffic lights 25, 26, 27. In particular, the traffic lights 25 may now be in the green signal state, while the traffic lights 26 and 27 are in the red signal state. Consequently, the probability for traffic lights 12 being in the green signal state is relatively high.

Furthermore, by means of the camera system 9, the state of movement of the further vehicles 13 and newly arrived further vehicles 17, 18 is determined. For example, it is found that the vehicle 13 now stands still in lane 22 in front of traffic lights 25. The further vehicle 17 may for example drive on lane 23 and vehicle 18 may drive on lane 24.

Furthermore, it may be determined by the camera system 9 that the truck 19 is now driving on lane 21, for example turning right into lane 24.

From these updated states of movement of the further vehicles 13, 17, 18, 19 it may be deduced that the probability for traffic lights 12 being green is high. Therefore, the correction value for the traffic lights 12 being green is now positive and may be added to the actual basic probability to determine the probability for green light of the traffic lights 12.

It is mentioned that the total probability, meaning the sum of the basic probability and the correction value, of green light and red light add up to a constant value.

In step 5 of the method, the probability for the traffic lights 12 being in green or red state may be computed by means of the computing unit 10 by adding up the respective basic value and the respective correction value.

In step 6 of the method, the vehicle guidance system 8 or the computing unit 10 may generate an information signal and provide the information signal in form of a visual or optical or acoustic or haptic feedback signal to a driver of the vehicle 7 or a user of the vehicle 7, wherein the information signal reflects the most probable actual signal state of the traffic lights 12.

Alternatively or in addition, in particular in case the vehicle 7 is designed as a self-driving vehicle, for example a level 5 self-driving vehicle according to SAE J3016, the guidance system 8 may control the vehicle 7 according to the probability for the traffic lights 12 being red or green.

By means of the improved concept, manually and/or automatically controlled vehicles may be controlled based on the signal state of traffic lights even though the traffic lights may be obstructed by some object, for example a truck, so that the drive and/or sensor system of the vehicle cannot see or recognize the actual signal state directly.

To this end, the ego vehicle makes use of the sensor system which may be equipped with one or more cameras that are able to detect traffic lights and vehicles in a scene. An HD-map with traffic light attributes is also used in several implementations.

By means of the improved concept, solid information regarding the actual state of traffic light device may be modelled even if it is not directly seen by respective sensors.

1. A method for determining a signal state of a traffic light device, the method comprising:
determining, by means of a sensor system of an ego vehicle, a state of movement of at least one further vehicle; and
determining a probability for the signal state by means of a computing unit of the ego vehicle depending on the determined state of movement.

2. The method according to claim 1, further comprising:
determining at least one further signal state of at least one further traffic light device by the sensor system and/or by means of a further sensor system,
receiving interrelation data by the computing unit from a database, the interrelation data comprising an interrelation between the signal state of the traffic light device and the at least one further signal state, and
determining the probability for the signal state depending on the interrelation data.

3. The method according to claim 2, wherein the interrelation data are received by the computing unit from a map database.

4. The method according to one of claim 2, further comprising:
determining a basic probability by the computing unit depending on the interrelation data; and
determining the probability for the signal state depending on the basic probability.

5. The method according to one claim 4, further comprising:
computing a correction value depending on the determined state of movement by the computing unit; and
determining the probability for the signal state as a sum of the basic probability and the correction value by means of the computing unit.

6. The method according to claim 1, wherein:
the state of movement of the at least one further vehicle is determined at a first time and at a second time by the sensor system,
a deviation between the state of movement determined at the first time from the state of movement determined at the second time is determined by the computing unit, and
the probability for the signal state is determined depending on the deviation.

7. The method according to claim 1, wherein:
an individual state of movement of each vehicle of the at least one further vehicle is determined by the sensor system,
a consistency of the individual states of movement is analyzed by the computing unit, and
the probability for the signal state is determined depending on a result of the analysis of the consistency.

8. The method according to claim 7, wherein:
a number of consistent vehicles is determined by the computing unit based on the individual states of movement, and
the probability for the signal state is determined depending on the number of consistent vehicles.

9. The method according to claim 1, wherein
the state of movement of the at least one further vehicle is determined repeatedly for consecutive frames of the sensor system,
a further consistency of the states of movement determined for the frames is analyzed means of the computing unit, and
the probability for the signal state is determined depending on a result of the analysis of the further consistency.

10. The method according to claim 1, wherein an information signal is generated by means of the computing unit depending on the probability for the signal state.

11. A method for automatic control of an ego vehicle, comprising:
determining a probability for a signal state of a traffic light device according to claim 1, and
controlling the ego vehicle by means of an electronic vehicle guidance system of the ego vehicle depending on the probability for the signal state.

12. The method according to claim 11, further comprising:
comparing the probability for the signal state to a predefined minimum confidence value by the computing unit; and
controlling the ego vehicle depending on a result of the comparison.

13. An electronic vehicle guidance system comprising:
a sensor system of an ego vehicle; and
a computing unit coupled to the sensor system,
wherein the sensor system is configured to determine a state of movement of at least one further vehicle, and
wherein the computing unit is configured to determine a probability for a signal state of a traffic light device depending on the determined state of movement.

14. The electronic vehicle guidance system according to claim 13, wherein:
the computing unit is configured to receive at least one further signal state of at least one further traffic light device,
the electronic vehicle guidance system comprises a database storing interrelation data, which comprise an interrelation between the signal state of the traffic light device and the at least one further signal state, and
the computing unit is configured to determine the probability for the signal state depending on the interrelation data.

15. A computer program comprising instructions that, when the computer program is executed by an electronic vehicle guidance system, cause the electronic vehicle guidance system to perform a method according to claim 1.
